(19) United States
(12) Patent Application Publication
(10) Pub. No.: US 2015/0127166 A1
(43) Pub. Date: May 7, 2015

(54) WAREHOUSE MANAGEMENT SYSTEM

(71) Applicant: Nobuyasu INAGAKI, Tokyo (JP)

(72) Inventor: Nobuyasu Inagaki, Tokyo (JP)

(21) Appl. No.: 14/397,578

(22) PCT Filed: Sep. 3, 2013
(86) PCT No.: PCT/JP2013/073623

§ 371 Date: Oct. 28, 2014

(30) Foreign Application Priority Data
Sep. 10, 2012 (JP) 2012198706

(51) Int. Cl. F24F 11/00; H04L 29/08; G05B 15/02

(52) U.S. Cl. CPC F24F 11/0009; G05B 15/02; H04L 67/10
USPC 700/276

(57) ABSTRACT

The purpose of the present invention is to provide a novel management system that is highly convenient for warehouse managers. A warehouse management system (10) comprises a host computer (core server) (20) and an Internet connection terminal (30) (personal computer (31), tablet terminal (32), portable terminal (33), or the like), The host computer (core server) (20) performs collection and maintenance of data from a control device (40) for a warehouse and performs management and operation of the control device (40). In addition, the Internet connection terminal (30) is connected via Internet to the host computer (core server) (20) and is capable of management and operation of the control device (40).

### TECHNICAL FIELD

The present invention relates to a warehouse management system that centralizedly and collectively manages environments in a plurality of warehouses.

### BACKGROUND ART

For bananas to be shipped to the market, bananas (of a green state) harvested in an immature state are first stored in a banana maturity processing room (hereinafter, “afterripening room”) called a “drying room,” its maturity state is controlled in the afterripening room, and then mature bananas are shipped to the market. This is referred to as a “banana afterripening process.” In the banana afterripening process, it is very important to manage the afterripening room, but it is a very convenient management system for a manager (a processor) for an afterripening process, and a technique disclosed in Patent Document 1 has been developed.

Meanwhile, as a cold chain (a low-temperature distribution system that distributes perishable food and the like while keeping a certain low temperature from a production stage to a consumption stage: adapted from “Ministry of Agriculture, Forestry and Fisheries of Japan”) is spread, there has been a need for environment management of temperature, humidity, and the like in storage warehouses or storage facilities.

### CITATION LIST

### Patent Document

Patent Document 1: JP 2010-166840 A

### DISCLOSURE OF THE INVENTION

### Problem to be Solved by the Invention

There have been management systems that manage environments of temperature, humidity, and the like in storage warehouses or storage facilities so far. However, a system matching the user's facility specification is very expensive, and, for example, when the user's facility is enlarged or changed, it is very difficult to flexibly adapt to it.

In this regard, the present inventor(s) achieved the present invention by solving the above problems, and it is an object of the present invention to provide a novel management system that is very convenient for a warehouse manager, similarly to an afterripening process management system for fruit and vegetables such as bananas.

### Means for Solving Problem

In order to achieve the above object, a first invention is a warehouse management system that centralizedly and collectively manages environments in a plurality of warehouses, and includes a host computer that collects data from a control device that controls an environment of a warehouse, holds data, and manages and operates the control device, and an Internet connecting terminal that is connected to the host computer via the Internet and is capable of managing and operating the control device, wherein monitor screens of the host computer and the Internet connecting terminal include a system setting screen used to select an afterripening mode or a refrigerator as an environment in a warehouse, a list screen that displays a list of warehouses by selection of a table-like form or an individual form, an individual room screen used to select an item that is desired to be displayed for control and monitoring for each warehouse, an advanced setting screen used to input a condition on an item selected through the individual room screen, and an operation screen on which the items selected through the individual room screen and the advanced setting screen are automatically arranged, the operation screen being used to control and monitor an inside of a warehouse.

A second invention is the same warehouse management system in which at least a temperature, a humidity, a ventilation, a CO2 density, ethylene, and a unit fan are provided as an item that is selected through the individual room screen and desired to be displayed for control and monitoring.

A third invention is the same warehouse management system in which items selected through the individual room screen and the advanced setting screen are automatically arranged and displayed on the operation screen in a form of a switch, a lamp, a graph, a temperature controller, or a humidity controller.

### Effect of the Invention

According to the present invention, the following effects are obtained.

(1) It is possible to select an item that is desired to control and monitor in a warehouse and simply customize a user specification.

(2) Further, overall control and monitoring are performed in real time through a conspicuous operation that is displayed on a monitor.

(3) Thus, for example, as a management criterion related to refrigeration and freezing is set, it is possible to collectively and centralizedly manage refrigeration and freezing environment. Specifically, it is possible to collectively and centralizedly manage refrigeration and freezing environment according to each warehouse. Further, it is possible to control and manage a plurality of branch offices or facilities (warehouses).

### BRIEF DESCRIPTION OF DRAWINGS

FIG. 1 is an explanatory diagram (schematic system diagram) illustrating a warehouse management system according to the present invention;

FIG. 2 is an explanatory diagram illustrating a system setting screen of a warehouse management system;

FIG. 3 is an explanatory diagram illustrating a list screen (a table-like form) of a warehouse management system;

FIG. 4 is an explanatory diagram illustrating a list screen (individual form) of a warehouse management system;

FIG. 5 is an explanatory diagram illustrating an individual room screen of a warehouse management system;

FIG. 6 is an explanatory diagram illustrating an advanced setting screen of a warehouse management system; and

FIG. 7 is an explanatory diagram illustrating an operation screen of a warehouse management system.

### MODE(S) FOR CARRYING OUT THE INVENTION

Hereinafter, an exemplary embodiment of the present invention will be described with reference to the appended drawings.

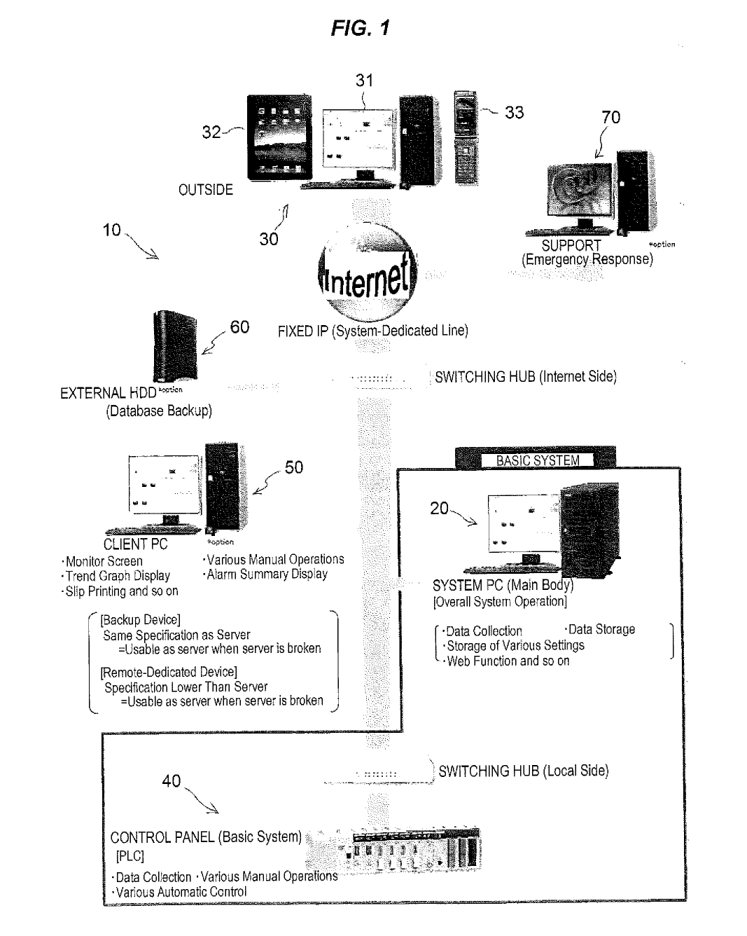

FIG. 1 is an explanatory diagram (schematic system diagram) illustrating a warehouse management system according to the present invention.

As illustrated in FIG. 1, a warehouse management system 10 according to the present invention includes a host computer (backbone server) 20 and Internet connecting terminals 30 (a personal computer (PC) 31, a tablet terminal 32, a mobile terminal 33, and the like). The host computer (backbone server) 20 collects data from a control device 40 of a warehouse, holds data, and manages and operates the control device 40. The Internet connecting terminal 30 is connected to the host computer (backbone server) 20 via the Internet, and capable of managing and operating the control device 40.

Further, a client PC 50, an external HOD 60, or a support (emergency response) terminal 70 may be provided as an option of the warehouse management system 10. Further, a monitoring camera may be installed in a warehouse, and a video captured by the monitoring camera may be output to a monitor screen of the host computer (backbone server) 20 or the Internet connecting terminal 30 so that a state in a warehouse can be displayed in real time.

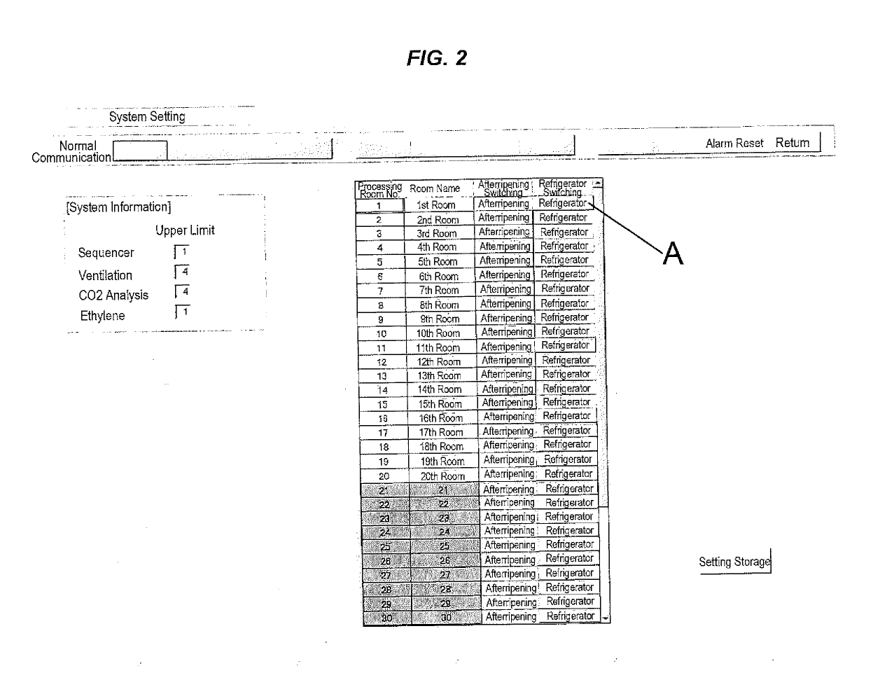

FIGS. 2 to 7 are explanatory diagrams illustrating exemplary monitor screens of the host computer (backbone server) 20 or the Internet connecting terminal 30.

FIG. 2 is an explanatory diagram illustrating a “system setting screen” of the warehouse management system 10. The system setting screen is a setting screen used to select an afterripening mode (for example, a banana afterripening process or the like) or a refrigerator (for example, an overall cold chain, freezing, or the like) as an environment in a warehouse.

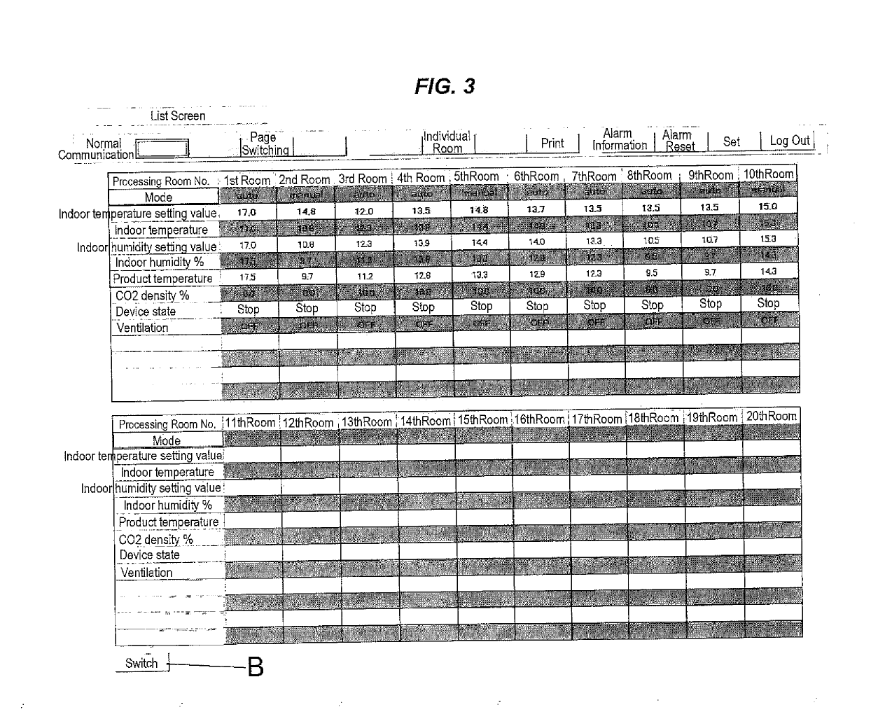

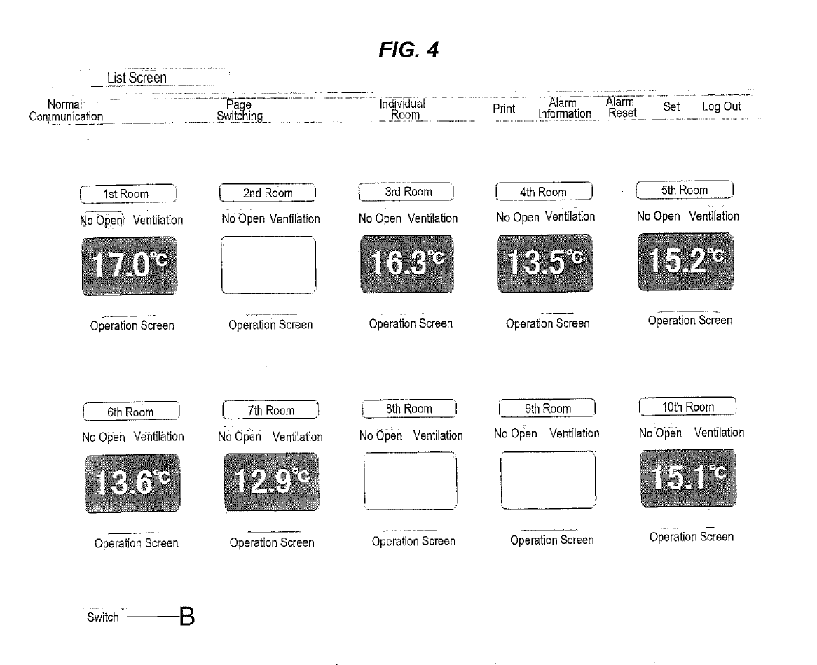

FIGS. 3 and 4 are explanatory diagrams illustrating a “list screen” of the warehouse management system 10, and FIG. 3 illustrates a “table-like form,” and FIG. 4 is an “individual form.” Switching (selection) between the table-like form and the individual form can be performed by a “switching button” on the lower left of the screen. Here, an item (temperature, humidity, CO₂ density, or the like) that is desired to be displayed can be selected.

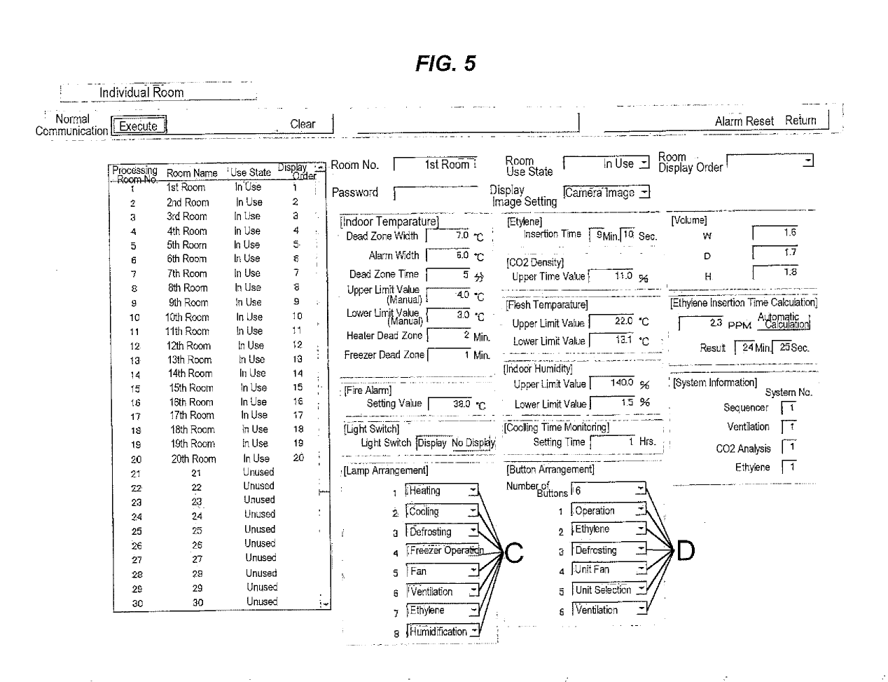

FIG. 5 is an explanatory diagram illustrating an “individual room screen” of the warehouse management system 10. The individual room screen is a setting screen used to select an item that is desired to be displayed for control and monitoring of a warehouse. Specifically, an item that is desired to be controlled and monitored is selected by a portion of “lamp arrangement” and “button arrangement” arranged in the lower center in the drawing.

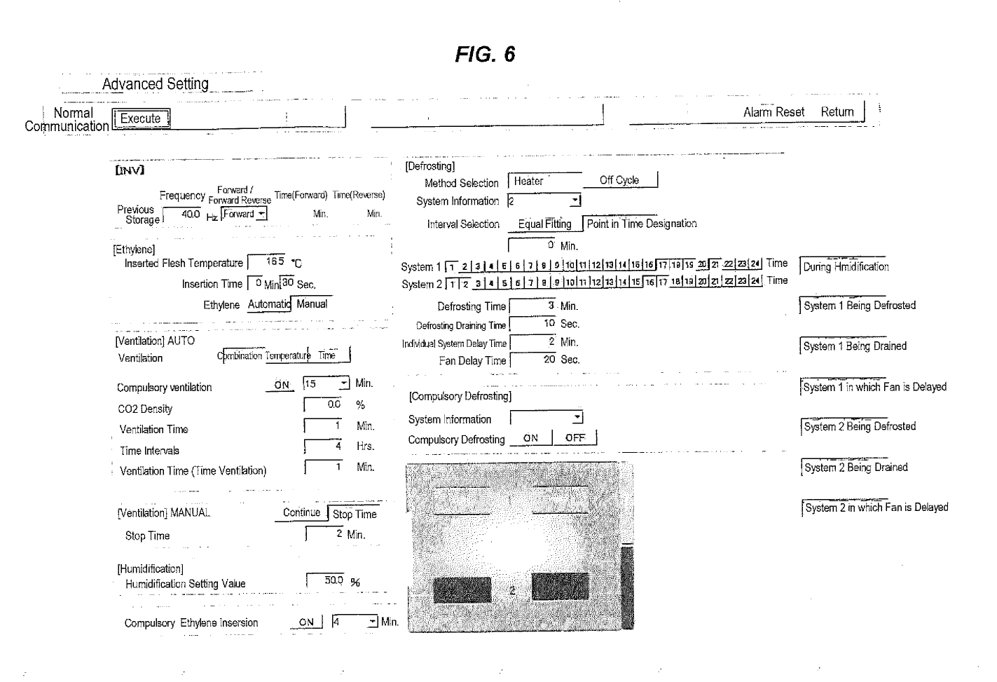

FIG. 6 is an explanatory diagram illustrating an “advanced setting screen” of the warehouse management system 10. The advanced setting screen is a setting screen (a detailed condition of an automatic mode, a security, and the like) used to input a condition to an item selected through the “individual room screen” of FIG. 5.

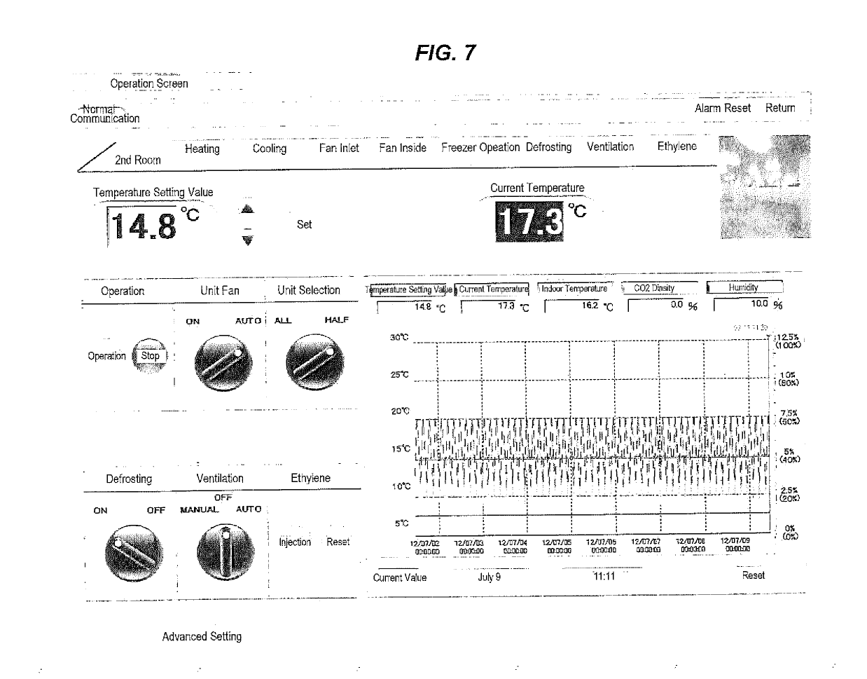

FIG. 7 is an explanatory diagram illustrating an “operation screen” of the warehouse management system 10. The operation screen is a screen on which items selected through the “individual room screen” of FIG. 5 and the “advanced setting screen” of FIG. 6 are automatically arranged, and used to perform control and monitoring of a warehouse.

The monitor screen of the warehouse management system 10 has been described so far, and a customization process of customizing the warehouse management system 10 is now described based on the above-described monitor screen.

1) In the system setting screen (FIG. 2), a refrigerator mode of A is selected.

2) In the list screen (FIGS. 3 and 4), a table-like form or an individual form is selected through a switching button of B.

3) In the individual room screen (FIG. 5), items C and D that are desired to be controlled and monitored are selected.

4) In the advanced setting screen (FIG. 6), the items selected through the individual room screen (FIG. 5) are displayed, and each condition is set.

5) As the individual room screen (FIG. 5) and the advanced setting screen (FIG. 6) are set, the items (a switch, a lamp, a graph, a temperature controller, a humidity controller, and the like) selected through the operation screen (FIG. 7) are automatically displayed.

Through the customization process, software having a specification desired by the user is completed. As the user's desire can be sufficiently satisfied, it is possible to support various users (various occupations) associated with a cold chain.

Further, items that can be controlled and monitored are listed according selection performed in the warehouse management system 10. Here, items that can be controlled and monitored are not limited to the following examples.
Temperature, humidity, CO2, ethylene, ventilation, freezer, and unit fan
Oxygen, nitrogen, product temperature monitoring (internal temperature), monitor video recording, and defrosting
Security management (temperature upper limit and lower limit, fire, device failure, confinement, and the like), and integral power consumption
Demand control and radiation dose
Monitoring information notification (a function of giving a notification through a mail or the like according to a setting of a necessary item even when a monitor is not checked)

### INDUSTRIAL APPLICABILITY

The present invention can be widely used as a management system that supports various users (various occupations) associated with a cold chain, and centralizedly and collectively manages an environment inside a warehouse or a facility in a wide range of storage warehouses or storage facilities. Particularly, since the present invention can be easily introduced or switched (customized) regardless of an existing system or a new-established system, a utility value thereof is very high.

### EXPLANATIONS OF LETTERS OR NUMERALS

10 Warehouse management system
20 Host computer (backbone server)
30 Internet connecting terminal
31 Personal computer (PC)
32 Tablet terminal
33 Mobile terminal
40 Control device
50 Client PC
60 External HDD
70 Support (emergency response) terminal

1. A warehouse management system that centralizedly and collectively manages environments in a plurality of warehouses, comprising:
a host computer that collects data from a control device that controls an environment of a warehouse, holds data, and manages and operates the control device; and
an Internet connecting terminal that is connected to the host computer via the Internet and is capable of managing and operating the control device,
wherein monitor screens of the host computer and the Internet connecting terminal include a system setting screen used to select an afterripening mode or a refrigerator as an environment in a warehouse, a list screen that displays a list of warehouses by selection of a table-like form or an individual form, an individual room screen used to select an item that is desired to be displayed for control and monitoring for each warehouse, an advanced setting screen used to input a condition on an item selected through the individual room screen, and an operation screen on which the items selected through the individual room screen and the advanced setting screen are automatically arranged, the operation screen being used to control and monitor an inside of a warehouse.

2. The warehouse management system according to claim 1,
wherein at least a temperature, a humidity, a ventilation, a CO2 density, ethylene, and a unit fan are provided as an item that is selected through the individual room screen and desired to be displayed for control and monitoring.

3. The warehouse management system according to claim 1,
wherein items selected through the individual room screen and the advanced setting screen are automatically arranged and displayed on the operation screen in a form of a switch, a lamp, a graph, a temperature controller, or a humidity controller.

4. The warehouse management system according to claim 2,
wherein items selected through the individual room screen and the advanced setting screen are automatically arranged and displayed on the operation screen in a form of a switch, a lamp, a graph, a temperature controller, or a humidity controller.
